(19) United States
(12) Patent Application Publication
(10) Pub. No.: US 2024/0392210 A1
(43) Pub. Date: Nov. 28, 2024

(54) Floating Wick

(71) Applicant: James P Janniello, Sarasota, FL (US)

(72) Inventor: James P Janniello, Sarasota, FL (US)

(21) Appl. No.: 18/754,806

(22) Filed: Jun. 26, 2024

Related U.S. Application Data
(63) Continuation-in-part of application No. 17/333,927, filed on May 28, 2021, now Pat. No. 12,060,993.

(51) Int. Cl. C11C 5/00

(52) U.S. Cl. CPC C11C 5/006

(57) ABSTRACT

A candlewick includes a flotation device, a wick, and a bracket configured to position a first portion of the wick above a waterline of the flotation device and to position a second portion of the wick below a waterline of the flotation device.

### CLAIM OF PRIORITY

This application is a continuation-in-part of U.S. patent application Ser. No. 17/333,927, filed on May 28, 2021, which is incorporated by reference herein in their entirety.

### TECHNICAL FIELD

The present application relates generally to the mechanical arts, and more specifically, in one example, to a floating wick.

### BACKGROUND

Candlewicks are conventionally embedded in a candle during manufacture while the candle wax is in a molten form. Once the wax hardens, the wick is maintained in a generally fixed position. If the wick fails, such as by burning off, the candle is often rendered useless. If the wick performs as intended, it must often be trimmed to a proper length by the user. In addition, the user is typically limited to the quantity and location of the wick(s) as determined at the time of manufacture of the candle. Similarly, wicks for kerosene lamps often have a fixed configuration, although the height of the wick above the surface of the kerosene may be mechanically adjustable.

### BRIEF DESCRIPTION OF THE DRAWINGS

Some embodiments are illustrated by way of example and not limitation in the figures of the accompanying drawings in which:

FIG. 1 is an illustration of a floating candlewick, in accordance with an example embodiment;

FIG. 2 illustrates a cross-sectional view of the floating candlewick of FIG. 1, in accordance with an example embodiment;

FIG. 3A is an illustration of the floating candlewick prior to embedding into solid wax, in accordance with an example embodiment;

FIG. 3B is an illustration of the floating candlewick after embedding into the solid wax, in accordance with an example embodiment;

FIG. 3C is an illustration of the floating candlewick while floating in the solid wax, in accordance with an example embodiment;

FIG. 4A is an illustration of a first example slotted floating candlewick prior to embedding into solid wax, in accordance with an example embodiment;

FIG. 4B illustrates a cross-sectional view of the first example slotted floating candlewick of FIG. 4A, in accordance with an example embodiment;

FIG. 5A is an illustration of the slotted floating candlewick of FIG. 4A with a slotted wick inserted, in accordance with an example embodiment;

FIG. 5B illustrates a cross-sectional view of the floating candlewick of FIG. 5A with the slotted wick inserted, in accordance with an example embodiment;

FIG. 6A is an illustration of the slotted floating candlewick of FIG. 4A incorporated with a brace, in accordance with an example embodiment;

FIG. 6B illustrates a cross-sectional view of the floating candlewick of FIG. 4B incorporated with the brace, in accordance with an example embodiment;

FIG. 7A is an illustration of a floating candlewick integrated with a wick cap, in accordance with an example embodiment;

FIG. 7B illustrates a cross-sectional view of the floating candlewick of FIG. 7A integrated with the wick cap, in accordance with an example embodiment;

FIG. 8A is an illustration of a floating candlewick integrated with a corkscrew base, in accordance with an example embodiment;

FIG. 8B illustrates a cross-sectional view of the floating candlewick of FIG. 8A integrated with the corkscrew base, in accordance with an example embodiment;

FIG. 9A is an illustration of the floating candlewick of FIG. 8A incorporated with an extendable wick, in accordance with an example embodiment; and

FIG. 9B illustrates a cross-sectional view of the floating candlewick of FIG. 9A incorporated with the extendable wick, in accordance with an example embodiment.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and mechanical and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

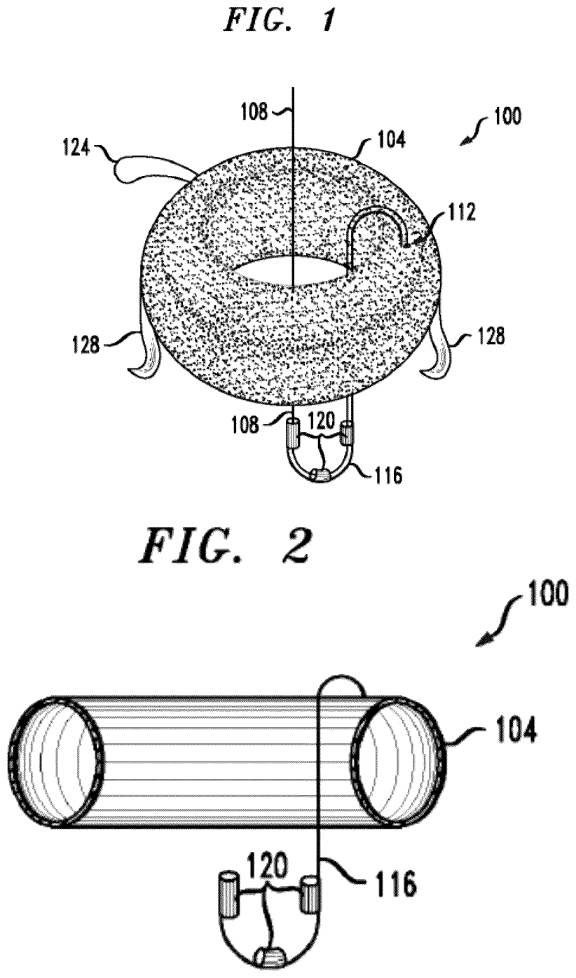

Generally, a floating wick, such as a floating candlewick, a floating kerosene wick, and the like, is described. FIG. 1 is an illustration of a floating candlewick 100, in accordance with an example embodiment. FIG. 2 illustrates a cross-sectional view of the floating candlewick 100 of FIG. 1, in accordance with an example embodiment. As illustrated in FIG. 1, a flotation device 104 provides a support structure for a wick 108 and provides buoyancy to float the floating candlewick 100 on molten wax, maintaining at least a portion of the wick 108 above the top surface of the molten wax and at least a portion of the wick 108 below the top surface of the molten wax (that is, within the molten wax). In one example embodiment, the flotation device 104 is in the shape of a hollow donut. Other shapes for the flotation device 104 are contemplated, such as a pair of parallel hollow logs, separated by a small distance (such as 0.5″), and joined by cross struts to form a generally rectangular or square shape. In one example embodiment, the flotation device 104 is constructed of an inflammable material, such as brass or aluminum. In one example embodiment, the floating candlewick 100, excluding the wick 108, is constructed of an inflammable material, such as brass or aluminum. A suitable range for the inner diameter of the flotation device 104 is approximately 0.25″ and greater, although other sizes are contemplated. The interior volume of the flotation device 104 and, correspondingly, the outer diameter of the flotation device 104 may be determined using conventional calculations for determining floatation specifications based on the overall weight of the floating candlewick 100.

In one example embodiment, a hole 112 in the top of the flotation device 104 provides access to the interior of the flotation device 104 for storage of a portion of the wick 108. In one example embodiment, a grommet (not shown) is installed in the hole 112 to protect the wick 108 from the circular edge of the flotation device 104 that defines the hole 112. Other shapes for the hole 112 are contemplated, such as a square, a rectangle, an oval, and the like.

In one example embodiment, a bracket 116 is attached to the flotation device 104 to configure the wick 108 to 1) have one segment of the wick 108 below the waterline of the flotation device 104 (such as extending 0.5″ below the waterline); and 2) have one end of the wick 108 above the waterline of the flotation device 104 (such as extending 0.5″ above the waterline). (As used herein, the waterline is a line that connects the points of the flotation device 104 where the flotation device 104 meets the surface of the molten wax when the floating candlewick 100 is floating.) In one example embodiment, the bracket 116 is j-shaped. In one example embodiment, one or more tubes 120 configure, shape, and position the wick 108 in relation to the flotation device 104, as described above. In one example embodiment, the tubes 120 are short in length, such as 0.125″. Short tubes 120 may be replaced with eyelets.

In one example embodiment, a handle 124 is attached to the top or side of the flotation device 104 to enable a user to remove the floating candlewick 100 from the wax. The exposed length of the wick 108 can then be adjusted to the desired length by pulling the wick 108 from the interior of the flotation device 104 or pushing the wick 108 into the interior of the flotation device 104. The floating candlewick 100 can then be embedded into the solid wax or floated on molten wax. In one example embodiment, the length of the tubes 120 is kept short, such as 0.25″, such that any wax build-up within the tube 120 will not prevent movement of the wick 108 through the tube 120.

In one example embodiment, one or more prongs 128 extend from the flotation device 104, as illustrated in FIGS. 1 and 2. In one example embodiment, the length of each prong 128 is 0.5″. The prongs 128 serve to mount the floating candlewick 100 into the surface of a solid block of wax. In one example embodiment, each prong 128 is in the shape of a corkscrew of a diameter that matches the outer circumference of the flotation device 104. In one example embodiment, the length of the corkscrew corresponds to an arc of less than 180 degrees, such as an arc of 22.5 degrees.

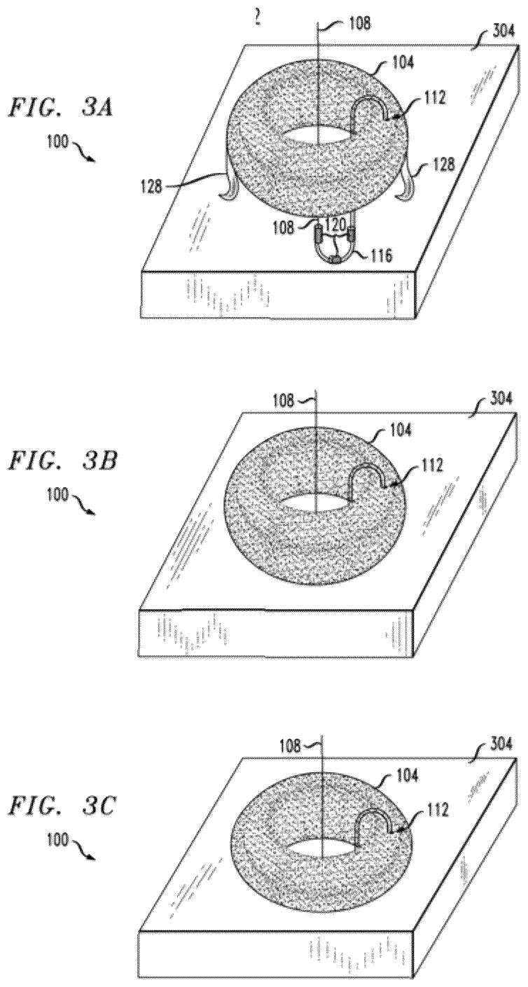

FIG. 3A is an illustration of the floating candlewick 100 prior to embedding into solid wax 304, in accordance with an example embodiment. To embed the floating candlewick 100, a user presses down on the flotation device 104 while rotating it clockwise. As the prongs 128 engage the solid wax 304, the prongs 128, the bracket 116, and the wick 108 become embedded in the wax, facilitated by the corkscrew shape of the prongs 128. FIG. 3B is an illustration of the floating candlewick 100 after embedding into the solid wax 304, in accordance with an example embodiment.

After the wick 108 is lit with a match or other device, the wax surrounding the floating candlewick 100 melts. As the wax becomes molten, the floating candlewick 100 begins floating on the surface of the wax 304. FIG. 3C is an illustration of the floating candlewick 100 while floating in the solid wax 304, in accordance with an example embodiment.

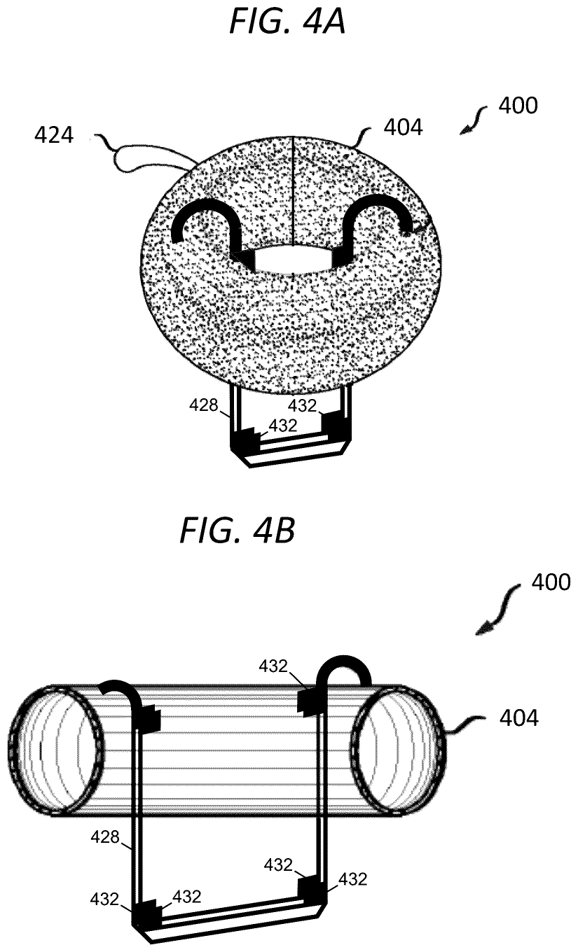

FIG. 4A is an illustration of a first example slotted floating candlewick 400 prior to embedding into solid wax, in accordance with an example embodiment. FIG. 4B illustrates a cross-sectional view of the first example slotted floating candlewick 400 of FIG. 4A, in accordance with an example embodiment. As illustrated in FIG. 4A, a flotation device 404 is attached to a support structure 428 for a slotted wick (such as a slotted wick constructed of wood) and provides buoyancy to float the floating candlewick 400 on molten wax, maintaining at least a portion of the slotted wick above the top surface of the molten wax and at least a portion of the slotted wick below the top surface of the molten wax (that is, within the molten wax). In one example embodiment, the flotation device 404 is in the shape of a hollow donut. Other shapes for the flotation device 404 are contemplated, such as a pair of parallel hollow logs, separated by a small distance (such as 0.5″), and joined by cross struts to form a generally rectangular or square shape. In one example embodiment, the flotation device 404 is constructed of an inflammable material, such as brass or aluminum. In one example embodiment, the floating candlewick 400, excluding the slotted wick, is constructed of an inflammable material, such as brass or aluminum. A suitable range for the inner diameter of the flotation device 404 is approximately 0.75″, although other sizes are contemplated. The interior volume of the flotation device 404 and, correspondingly, the outer diameter of the flotation device 404 may be determined using conventional calculations for determining floatation specifications based on the overall weight of the floating candlewick 400.

In one example embodiment, the support structure 428 is attached to the flotation device 404 to configure the slotted wick to 1) have one segment of the slotted wick below the waterline of the flotation device 404 (such as extending 0.5″ below the waterline); and 2) have one end of the slotted wick above the waterline of the flotation device 404 (such as extending 0.5″ above the waterline). (As noted above, the waterline is a line that connects the points of the flotation device 404 where the flotation device 404 meets the surface of the molten wax when the floating candlewick 400 is floating.) In one example embodiment, the support structure 428 is rectangular in shape and configured to surround at least a portion of the slotted wick. (Other shapes are contemplated, including square, circular, triangular and the like. The triangular embodiment may have one or two vertices configured above the waterline.) In one example embodiment, supports 432 are configured to hold the slotted wick within the support structure 428.

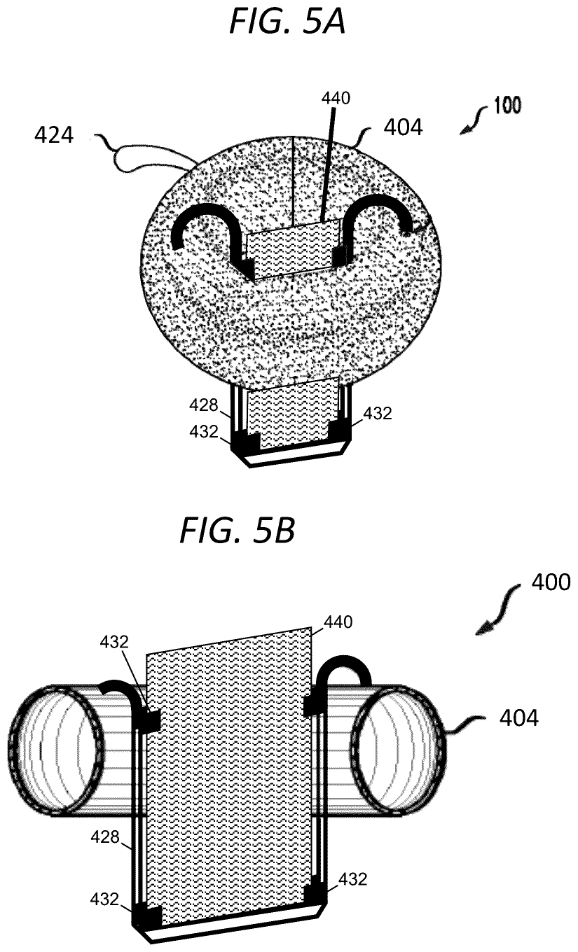

FIG. 5A is an illustration of the slotted floating candlewick 400 of FIG. 4A with a slotted wick 440 inserted, in accordance with an example embodiment. FIG. 5B illustrates a cross-sectional view of the floating candlewick 400 of FIG. 5A with the slotted wick 440 inserted, in accordance with an example embodiment. As noted above, supports 432 are configured to hold the slotted wick within the support structure 428.

In one example embodiment, a handle 424 is attached to the top or side of the flotation device 404 to enable a user to remove the floating candlewick 400 from the wax. The floating candlewick 400 can then be embedded into the solid wax or floated on molten wax.

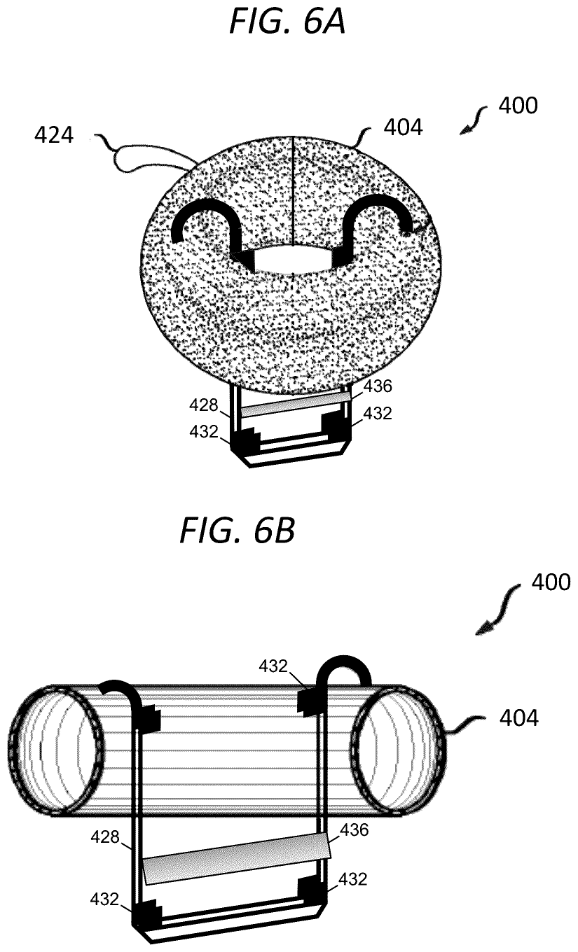

FIG. 6A is an illustration of the slotted floating candlewick 400 of FIG. 4A incorporated with a brace 436, in accordance with an example embodiment. FIG. 6B illustrates a cross-sectional view of the floating candlewick 400 of FIG. 4B incorporated with the brace 436, in accordance with an example embodiment. In one example embodiment, the brace 436 is angled as illustrated in FIGS. 6A and 6B to direct portions of the solid wax towards the slotted wick 440 as the slotted floating candlewick 400 is pressed into the solid wax to enhance a coupling of the solid wax with the slotted wick 440. In one example embodiment, a plurality of braces 436 are similarly attached on both sides of the support structure 428 to direct portions of the solid wax towards the slotted wick 440.

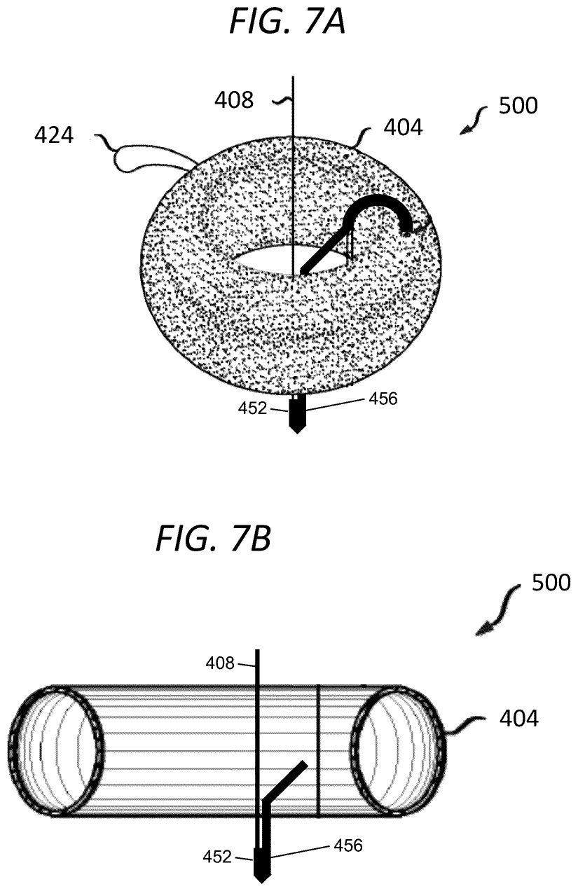

FIG. 7A is an illustration of a floating candlewick 500 integrated with a wick cap 452, in accordance with an example embodiment. FIG. 7B illustrates a cross-sectional view of the floating candlewick 500 of FIG. 7A integrated with the wick cap 452, in accordance with an example embodiment. In the example embodiment of FIGS. 7A-7B, the wick cap 452 caps the end of the wick 408. The wick cap 452 may be secured to the wick using an adhesive, a compression fitting (such as formed by compressing a metal cap onto the wick 408) and the like. In one example embodiment, the wick 408 is replaceable; an original wick 408 can be pulled from the wick cap 452 and a replacement wick 408 can be inserted into the wick cap 452. A post 456 couples the wick cap 452 to the floatation device 404 using techniques such as soldering, welding, pressure fittings and the like. The wick cap 452 and post 456 may be constructed using, for example, the inflammable materials identified above. In one example embodiment, the bottom of the wick cap 452 is pointed to assist with an insertion of the floating candlewick 500 into the solid wax.

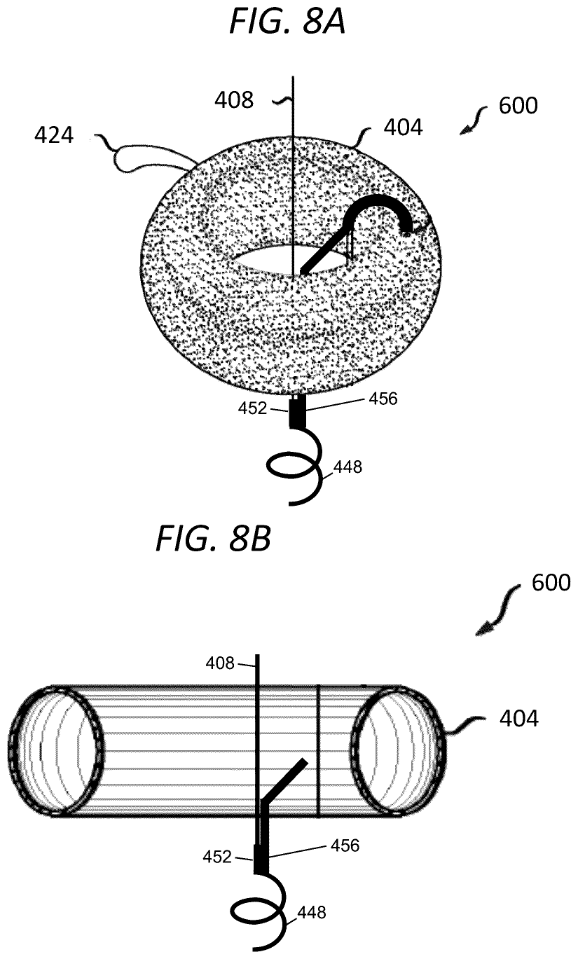

FIG. 8A is an illustration of a floating candlewick 600 integrated with a corkscrew base 448, in accordance with an example embodiment. FIG. 8B illustrates a cross-sectional view of the floating candlewick 600 of FIG. 8A integrated with the corkscrew base 448, in accordance with an example embodiment. In the example embodiment of FIGS. 8A-8B, a corkscrew 448 is attached to the post 456, the wick cap 452 or both. The wick cap 452, post 456 and the corkscrew 448 may be constructed using, for example, the inflammable materials identified above. In the example embodiment of FIGS. 8A-8B, the wick cap 452 caps the end of the wick 408. The wick cap 452 may be secured to the wick using an adhesive, a compression fitting (such as formed by compressing a metal cap onto the wick 408) and the like. In one example embodiment, the wick 408 is replaceable; an original wick 408 can be pulled from the wick cap 452 and a replacement wick 408 can be inserted into the wick cap 452.

The corkscrew 448 is configured to embed the wick cap 452 and the wick 408 into the solid wax by rotating the floating candlewick 600 as the floating candlewick 500 is inserted into the solid wax. The length of the corkscrew 448 is, for example, one inch, the diameter of the corkscrew 448 is, for example, 0.5 inches and the number of revolutions of the corkscrew 448 is, for example, two (as illustrated in FIG. 8B).

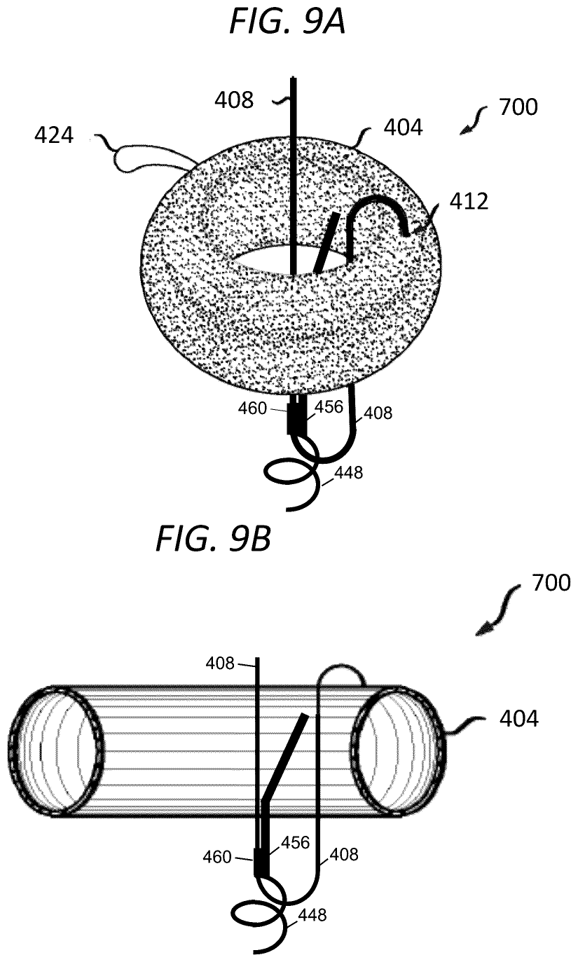

FIG. 9A is an illustration of the floating candlewick 700 of FIG. 8A incorporated with an extendable wick 408, in accordance with an example embodiment. FIG. 9B illustrates a cross-sectional view of the floating candlewick 700 of FIG. 9A incorporated with the extendable wick 408, in accordance with an example embodiment. In the example embodiment of FIGS. 9A-9B, the wick cap 452 is replaced with a short tube 460 that is attached to the post 456. (In example embodiments, the short tube 460 is an eyelet.) As described above, the exposed length of the wick 108 can be adjusted to the desired length by pulling the wick 108 from the interior of the flotation device 104 or pushing the wick 108 into the interior of the flotation device 104 via the short tube 460. In the example embodiment of FIGS. 9A-9B, a corkscrew 448 is attached to the post 456, the short tube 460 or both. The short tube 460, the post 456 and the corkscrew 448 may be constructed using, for example, the inflammable materials identified above.

The corkscrew 448 is configured to embed the wick cap 452 and the wick 408 into the solid wax by rotating the floating candlewick 500 as the floating candlewick 500 is inserted into the solid wax. The length of the corkscrew 448 is, for example, one inch, the diameter of the corkscrew 448 is, for example, 0.5 inches and the number of revolutions of the corkscrew 448 is, for example, two (as illustrated in FIG. 9B).

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A floating wick, the floating wick comprising:
a flotation device;
a wick; and
a bracket configured to position a first portion of the wick above a waterline of the flotation device, to position a second portion of the wick below the waterline of the flotation device and to embed a third portion of the wick into solid wax, the third portion comprising at least a portion of the second portion.

2. The floating wick of claim 1, wherein the flotation device is hollow and accommodates a third portion of the wick in an interior volume of the flotation device.

3. The floating wick of claim 1, wherein the flotation device and bracket are constructed of an inflammable material.

4. The floating wick of claim 1, the floating wick further comprising a grommet, the grommet residing in a hole in the flotation device to protect the wick from an edge of the flotation device, the edge defining the hole.

5. The floating wick of claim 1, wherein the waterline is a line that connects points of the flotation device where the flotation device meets the surface of the molten wax when the floating wick is floating.

6. The floating wick of claim 1, wherein the bracket is j-shaped.

7. The floating wick of claim 1, the floating wick further comprising one or more tubes attached to the bracket, the one or more tubes configured to configure, shape, and position the wick in relation to the flotation device.

8. The floating wick of claim 1, the floating wick further comprising a handle, the handle being attached to the flotation device and configured to enable a user to lift the floating candlewick.

9. The floating wick of claim 1, wherein an exposed length of the wick is adjustable.

10. The floating wick of claim 9, wherein the exposed length of the wick is adjustable by pulling the wick from the interior of the flotation device or pushing the wick into the interior of the flotation device.

11. The floating wick of claim 1, the floating wick further comprising one or more prongs that extend from the flotation device.

12. The floating wick of claim 11, wherein the one or more prongs are configured to mount the floating wick into a surface of a block of wax.

13. The floating wick of claim 12, wherein each prong is configured in a shape of a corkscrew.

14. The floating wick of claim 13, wherein a diameter of the shape of the corkscrew equals an outer circumference of the flotation device.

15. The floating wick of claim 14, wherein a length of each prong corresponds to an arc of less than 180 degrees.

16. The floating wick of claim 1, wherein the bracket is configured to accommodate a slotted wick.

17. The floating wick of claim 1, further comprising a wick cap, wherein the wick cap is attached to the bracket and is configured to surround at least a portion of the wick.

18. The floating wick of claim 1, further comprising a corkscrew base, wherein the corkscrew base is coupled to the bracket.

19. The floating wick of claim 1, further comprising a tube and a corkscrew base, wherein the tube is coupled to the bracket, wherein the corkscrew base is coupled to the bracket and wherein the tube is configured to surround at least a portion of the wick.
